(19) United States
(12) Patent Application Publication
(10) Pub. No.: US 2003/0029914 A1
(43) Pub. Date: Feb. 13, 2003

(54) Pre-paid payment device and method therefor

(76) Inventors: Daniel P. Hortman, Altanta, GA (US); Thomas Hortman, Kathleen, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/266,658

(22) Filed: Oct. 8, 2002

(51) Int. Cl. G06K 15/00

(52) U.S. Cl. 235/383

(57) ABSTRACT

A pre-paid payment device and method therefore, wherein the pre-paid payment device functions substantially similar to a credit card, yet permits a consumer to purchase goods and/or services from either an electronic retailer conducting business via a global networking system, without the risk of consumer information theft, consumer electronic-purchase tracking, and/or impingement of consumer anonymity and/or privacy.

### TECHNICAL FIELD

The present invention relates generally to currency systems and methods, and more specifically to a pre-paid payment device and method therefor. The present invention is particularly suitable for, although not strictly limited to, the secured and confidential purchasing of goods and/or services from electronic-commerce-based (i.e., E-commerce) retailers.

### BACKGROUND OF THE INVENTION

Credit cards are a type of consumer payment device utilized to access a line of credit to make purchases. Whether a general purpose or private label credit card, most consumers utilize the offered convenience of credit cards in situations where immediate funds may not be accessible and/or available, or in situations where the consumer desires to delay payment until a more convenient period arises. Although credit cards have their clear advantages, it is commonly known that credit cards possess inherent disadvantages that can render their use and/or possession impractical, uneconomical and, in certain scenarios, financially insecure.

Specifically, many consumers have experienced and/or continue to experience credit card debt as a result of overcharging, impulsive buying and/or non-frugal purchasing in general. Combined with increasing financial interest charges, owning a credit card can be more financially harmful than helpful, exponentially contributing to consumer debt.

Others still, have experienced the obvious ramifications of credit card theft and/or theft of associated credit card information—credit card number, name, and the like—often discovering unauthorized and/or unexplained charges on their monthly financial statements.

The aforementioned disadvantages, however, are not exclusive to a particular type of consumer-purchasing forum. In fact, credit card transactions via E-commerce are subject to increased theft risks and/or security breaches. Although encrypted secure-socket-layer access points are available through various E-commerce vendors (i.e., Electronic retailers or E-tailers) for credit card payment purposes, most such secure-socket-layer access points are still susceptible to intrusion via computer/software crackers who steal the consumer's identity and/or credit card number to make unauthorized purchases.

Additionally, utilization of a credit card to make a purchase inherently results in disclosure of personal consumer information—name, home address and/or telephone number—precluding or eliminating any privacy the consumer may desire in purchasing the goods and/or services. Moreover, some credit card transactions require the presentation of an additional form of consumer identification, thus further infringing on the consumer's desired anonymity and/or privacy.

Therefore, it is readily apparent that there is a need for a pre-paid payment device and method therefore, wherein the pre-paid payment device provides for the secured and confidential purchase of goods and/or services from an electronic retailer conducting business over a global networking system.

### BRIEF SUMMARY OF THE INVENTION

Briefly described, in a preferred embodiment, the present invention overcomes the above-mentioned disadvantages and meets the recognized need for such a device by providing a pre-paid payment device and method therefor (hereinafter periodically referred to as “payment device”), wherein the payment device functions substantially similar to a credit card, yet permits a consumer to purchase goods and/or services from an electronic retailer (i.e., E-tailer) conducting business via a global networking system, without the risk of consumer information theft, consumer electronic-purchase tracking, and/or impingement of consumer anonymity and/or privacy.

According to its major aspects and broadly stated, the present invention in its preferred form is a pre-paid payment device and method therefor, wherein the payment device is a fixed or variable value cash card possessing a card number.

More specifically, the present invention is a pre-paid payment device and method therefor, wherein the payment device is a fixed or variable value cash card possessing a personal identification number and/or card number, and wherein the payment device functions similar to a conventional credit card, but without the aforementioned associated disadvantages. To maintain consumer anonymity/privacy, the payment device is preferably utilized to implement purchases over a global networking system from an electronic retailer (i.e., E-tailer), but may, in an alternate embodiment, be made available and/or utilized in-person at a conventionally accessible retail outlet/store. Preferably, a supplier of the payment device supplies valueless payment devices to a physical retail outlet free-of-charge. In turn, the physical retail outlet sells the payment devices to a consumer for a fixed and/or variable cash value of the payment device plus a surcharge/activation fee. If the consumer desires a preset or fixed-value payment device, then the consumer preferably pays the physical retail outlet an amount equivalent to the value of the fixed-value cash card in addition to the activation fee, wherein the activation fee is retained by the physical retail outlet, and wherein the monetary amount paid for the card by the consumer is transferred to the supplier. If the consumer desires a variable value payment device, then the consumer preferably provides the physical retail outlet with the desired amount of funds to be placed upon the payment device/cash card in addition to the activation fee, wherein the activation fee is retained by the physical retail outlet, and wherein the monetary amount paid for the card by the consumer is transferred to the supplier.

Once the payment device is activated by the physical retail outlet, the consumer preferably purchases goods and/or services from an E-tailer by accessing the E-tailer's on-line payment-access-point and entering therein the payment device/cash card number—similar to methods of on-line purchasing via conventional credit cards. The E-tailer provides the goods/services to the consumer and thereafter, seeks payment for the goods/services from the supplier. The supplier in turn, pays the E-tailer for the value of the goods/services, wherein the supplier draws funds from the amount transferred to it by the physical retail outlet derived from the consumer's initial purchase of the payment device. The supplier further charges the E-tailer a processing/transaction fee. Although the method is similar to methods associated with credit card transactions, the consumer's utilization of the payment device to purchase a particular/desired good/service remains entirely anonymous and/or private. Additionally, should the payment device information of the on-line consumer be stolen, the maximum value of theft would be equivalent to the value of the payment device, thus drastically limiting overall monetary/financial loss by the on-line consumer.

A feature and advantage of the present invention is its ability to limit the amount of monetary/financial loss associated with theft of E-commerce transactional information.

A feature and advantage of the present invention is its ability to function similarly to a conventional credit card, but without the risk of consumer information theft, consumer electronic-purchase tracking, and/or impingement of consumer anonymity and/or privacy.

A feature and advantage of the present invention is its ability to assist a consumer in reducing credit card debt.

A feature and advantage of the present invention is its ability to function as a fixed or variable value cash card.

A feature and advantage of the present invention is its ability to be procured and utilized by any consumer, eliminating the need for credit-history checks and/or credit approval processes commonly associated with procuring a general purpose and/or private label credit card.

A feature and advantage of the present invention is its ability to be utilized by a consumer without annual fees, high interest rates, finance charges and/or maintenance charges typically associated with general purpose and/or private label credit cards.

A feature and advantage of the present invention is its ability to be utilized by a consumer without the need of supplying the physical retail outlet with additional identification.

A feature and advantage of the present invention is its ability to function as a consumer-regulated budget-card, thus assisting consumers in reducing/eliminating consumer-debt.

A feature and advantage of the present invention is its ability to be accepted by any E-tailer.

A feature and advantage of the present invention is its ability to limit the amount of monetary loss to the value of the cash card should the cash card be stolen, lost, misplaced and/or the cash card information stolen.

A feature and advantage of the present invention is its ability to permit a consumer to place any amount of cash onto the cash card.

A feature and advantage of the present invention is its ability to assist consumers in regulating their on-line spending.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a front view of a pre-paid payment device according to a preferred embodiment of the present invention.

FIG. 2 is a flow diagram of the method of use of a pre-paid payment device according to a preferred embodiment of the present invention.

FIG. 3 is a flow diagram of the method of use of a pre-paid payment device according to an alternate embodiment of the present invention.

FIG. 4 is a flow diagram of the method of use of a pre-paid payment device according to an alternate embodiment of the present invention.

FIG. 5 is a flow diagram of the method of use of a pre-paid payment device according to an alternate embodiment of the present invention.

### DETAILED DESCRIPTION OF THE PREFERRED AND ALTERNATIVE EMBODIMENTS

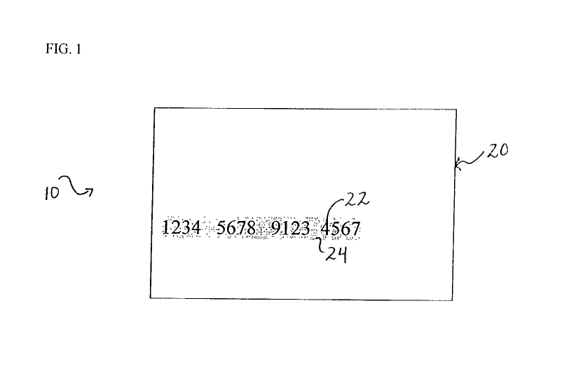

In describing the preferred and alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in its preferred embodiment is a payment device 10, preferably in the form of a card 20 having a personal-identification-number or card number 22, wherein card 20 preferably possesses a size and shape substantially similar to a conventionally available credit card, and wherein card number 22 preferably possesses a number of digits equivalent to the number of digits of a conventional credit card number, thus facilitating a method of use substantially similar to that of a conventionally available credit card. Card number 22 is preferably concealed via scratch-off film 24, wherein a user of device 10 preferably scratches off film 24 from card 20 to expose card number 22. Card 20 preferably does not possess a user name or any other form of user identification, thus promoting anonymity and/or privacy of consumer purchases. Preferably, device 10 is available as a fixed value cash card and/or variable value cash card, as more fully described below.

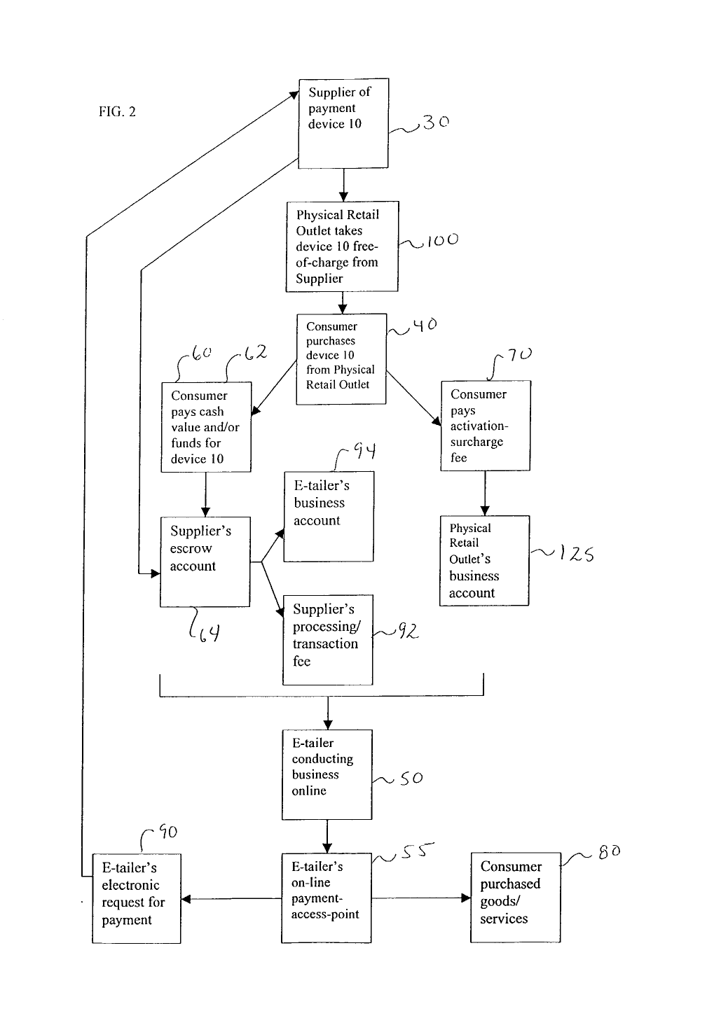

Referring now to FIG. 2, to maintain consumer 40 anonymity/privacy, payment device 10 is preferably utilized to implement purchases over a global networking system from an electronic retailer (i.e., E-tailer) 50. Preferably, supplier 30 of payment device 10 gives valueless payment devices 10 to physical retail outlet 100 free-of-charge, wherein physical retail outlet 100 is any conventionally accessible retail store. In turn, physical retail outlet 100 sells payment devices 10 to consumer 40 for a fixed and/or variable cash value 60 and/or 62, respectively, plus surcharge/activation fee 70. Preferably, device 10 possesses no value when initially supplied to physical retail outlet 100 by supplier 30, but attains value upon consumer 40 purchasing card 20 from physical retail outlet 100 for fixed and/or variable cash value 60 and/or 62, respectively, and upon activation of card 20 by physical retail outlet 100, as more fully described below.

Specifically, if consumer 40 desires a pre-set or fixed-value payment device 10, then consumer 40 preferably pays physical retail outlet 100 an amount equivalent to the cash value 60 of the fixed value payment device 10 in addition to activation fee 70. If consumer desires a variable-value payment device 10, then consumer 40 preferably provides physical retail outlet 100 with a desired amount of funds 62 to be placed upon payment device 10 in addition to activation fee 70. Upon payment for payment device 10 by consumer 40, physical retail outlet 100 preferably activates device 10 via any suitable payment device activation methods as known within the art, such as, for exemplary purposes only, swiping and activating card 20 via an incorporated magnetic strip on card 20, activating card 20 via a global networking system and/or telephone activation. Consumer 30 may purchase payment device 10 from physical retail outlet 100 via personal credit card, money order, cashier's check, wire-transfers and/or any other means as known within the art. Thereafter, cash value 60 and/or funds 62 are preferably transferred to supplier 30 by physical retail outlet 100 and held in supplier's 30 escrow account 64 for future payment to E-tailer 50 (as more fully described below), wherein activation/surcharge fee 70 is preferably deposited into business account 125 of physical retail outlet 100 as an earned profit. Although payment device 10 is preferably sold to consumers 40 via physical retail outlet 100, it is contemplated in an alternate embodiment that physical retail outlet 100 could supply/sell payment device 10 to consumer 40 via any suitable means as known with the art of sales, such as, for exemplary purposes only, websites, associated distributors and/or vending machines. Furthermore, although payment device 10 is preferably in the form of a tangible card 20, it is contemplated in an alternate embodiment that consumer 40 could request that only card number 22 of his/her purchased payment device 10 be given to him/her upon purchase of card 20 from physical retail outlet 100.

Upon supplier's 30 confirmation of receipt/payment of cash value 60 and/or funds 62, and following activation of payment device 10 by physical retail outlet 100, consumer 40 is ready to purchase goods and/or services from E-tailer 50 via known global networking systems. Preferably, consumer 40 purchases on-line goods and/or services from E-tailer 50 by accessing E-tailer's 50 on-line payment-access-point 55 and entering therein card number 22 of payment device 10—similar to methods of on-line purchasing via conventional credit cards. Due to card number 22 preferably possessing a number of digits equivalent to the number of digits of a conventional credit card number, on-line payment-access-point 55 of E-tailer 50 will read and accept card number 22 of card 20 without error and/or confusion. Thereafter E-tailer 50 preferably provides/delivers the purchased goods/services 80 to consumer 40 via any suitable delivery means as known with the art. Subsequently, E-tailer 50 preferably seeks remittance of payment for goods/services 80 from supplier 30 preferably via electronic request 90, wherein electronic request 90 is preferably any suitable electronic request for remittance of payment as known within the art of E-commerce and/or E-business.

Supplier 30 in turn, preferably remits payment to E-tailer 50 via accessing escrow account 64, and electronically wiring/transferring cash value 60 and/or funds 62 into business account 94 of E-tailer 50. It is contemplated in an alternate embodiment that supplier 30 could remit payment to E-tailer 50 via any suitable electronic remittance of payment as known within the art of E-commerce and/or E-business. Prior to remitting payment to E-tailer 50, supplier 30 preferably deducts processing/transaction fee 92 from cash value 60 and/or funds 62, wherein processing/transaction fee 92 is preferably deposited into supplier's business account 75. Although the preferred method of use of payment device 10 is similar to methods associated with conventional credit card transactions, one aspect of the novelty of the present invention resides in private and/or anonymous utilization of payment device 10 by consumer 40 to purchase a particular/desired good/service. Specifically, any attempts to track consumer's 40 purchase would result in revealing only card number 22 of payment device 10, as no credit history, home address, birth name and/or any other related personal information is required to purchase payment device 10 from physical retail outlet 100—only a confirmation of receipt/payment of cash value 60 and/or funds 62 and activation/surcharge fee 70. Additionally, should card number 22 of consumer's 40 payment device 10 be stolen either on-line or from his/her person, the maximum value of theft would be equivalent to the value of payment device 10, thus drastically limiting overall monetary/financial loss by consumer 40.

When consumer 40 has exhausted all funds available on card 20 of payment device 10, consumer 40 preferably renews payment device 10 via contacting supplier 30 and/or physical retail outlet 100 and depositing funds back thereon. Alternatively, consumer 40 can discard the exhausted payment device 10, and request/purchase another from physical retail outlet 100 via the aforementioned preferred and/or alternate processes. Furthermore, card number 22 is preferably capable of being changed by consumer 40 via accessing supplier's 30 available website and changing card number 22 thereon, thus further ensuring anonymity and/or privacy of purchases made by consumer 40. Payment device 10 further preferably possesses an expiration date that may be recorded electronically by supplier 30 upon activation of payment device 10 by physical retail outlet 100, or may be physically entered/written onto card 20 by personnel working at physical retail outlet 100, and/or by consumer 40, wherein the expiration date is preferably variable to permit extended use of payment device 10 upon renewal of same.

Although its is preferred that consumer 40 renew payment device 10 via directly contacting supplier 30 and/or physical retail outlet 100, it is contemplated in an alternate embodiment that consumer 40 could renew payment device 10 via any suitable method as known within the art, such as, for exemplary purposes only, via utilizing an automatic-teller-machine (i.e., ATM machine) to effect a direct wire-transfer onto payment device 10 from consumer's 40 bank account, via on-line paid renewal and/or via card-value renewal machines.

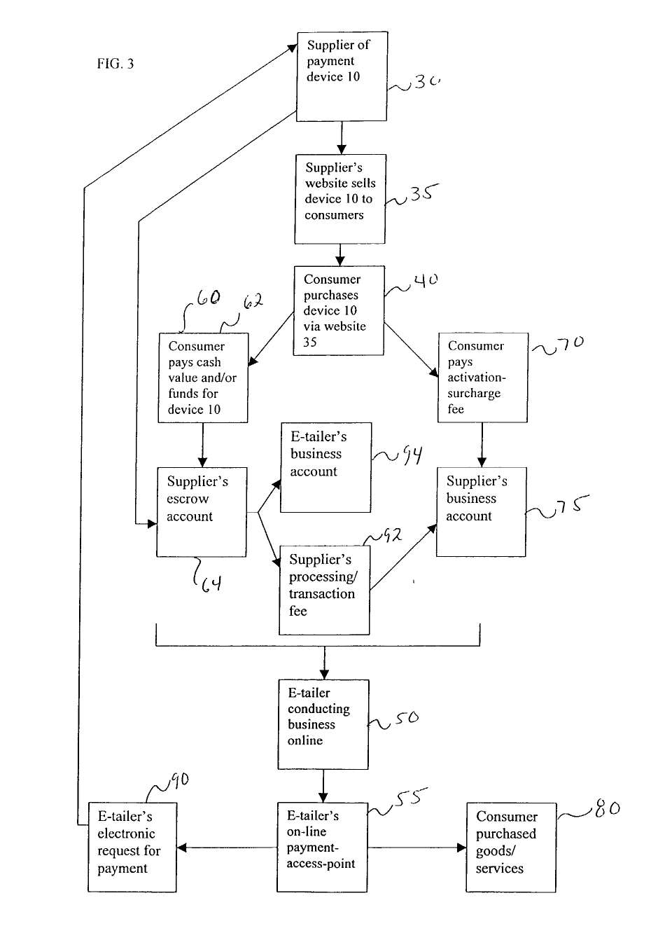

Referring now to FIG. 3, the present invention in an alternate embodiment is a payment device 10, wherein payment device 10 is utilized to implement purchases over a global networking system from an electronic retailer (i.e., E-tailer) 50 to maintain consumer 40 anonymity/privacy. Supplier 30 of payment device 10 sells payment device 10 to consumer 40 via supplier's 30 website 35, wherein consumer 40 pays for the cash value 60 of payment device 10 plus a surcharge/activation fee 70. If consumer 40 desires a pre-set or fixed-value payment device 10, then consumer 40 pays supplier 30 an amount equivalent to the cash value 60 of the fixed-value payment device 10 in addition to activation fee 70. If consumer desires a variable value payment device 10, then consumer 40 provides supplier 30 with a desired amount of funds 62 to be placed upon payment device 10 in addition to activation fee 70. Supplier 30 sells consumer 40 payment device 10 via supplier's 30 website 35, wherein consumer 30 may purchase payment device 10 via personal credit card, money order, cashier's check, wire-transfers and/or any other means as known within the art. Thereafter, cash value 60 and/or funds 62 are held in supplier's 30 escrow account 64 for future payment to E-tailer 50 (as more fully described below), wherein activation/surcharge fee 70 is deposited into supplier's 30 business account 75, and wherein consumer 40 receives payment device 10 via postal mail and/or via any other suitable delivery means. Although payment device 10 is sold to consumers 40 via supplier's 30 website 35, it is contemplated in another alternate embodiment that supplier 30 could supply/sell payment device 10 to consumer 40 via any suitable means as known with the art of sales, such as, for exemplary purposes only, direct-sale, distributors and/or vending machines. Furthermore, although payment device 10 is in the form of a tangible card 20, it is contemplated in another alternate embodiment that consumer 40 could request that only card number 22 of his/her purchased payment device 10 be sent via electronic-mail (i.e., E-mail), thus eliminating the need to await receipt of card 20 via regular postal mail.

Upon supplier's 30 confirmation of receipt/payment of cash value 60 and/or funds 62 and activation/surcharge fee 70, and following activation of payment device 10 and receipt thereof by consumer 40, consumer 40 is ready to purchase goods and/or services from E-tailer 50 via known global networking systems. Consumer 40 purchases on-line goods and/or services from E-tailer 50 by accessing E-tailer's 50 on-line payment-access-point 55 and entering therein card number 22—similar to methods of on-line purchasing via conventional credit cards. Due to card number 22 possessing a number of digits equivalent to the number of digits of a conventional credit card number, on-line payment-access-point 55 of E-tailer 50 will read and accept card number 22 of card 20 without error and/or confusion. Thereafter E-tailer 50 provides/delivers the purchased goods/services 80 to consumer 40 via any suitable delivery means as known with the art. Subsequently, E-tailer 50 seeks remittance of payment for goods/services 80 from supplier 30 via electronic request 90, wherein electronic request 90 is any suitable electronic request for remittance of payment as known within the art of E-commerce and/or E-business.

Supplier 30 in turn, remits payment to E-tailer 50 via accessing escrow account 64, and electronically wiring/transferring cash value 60 and/or funds 62 into business account 94 of E-tailer 50. It is contemplated in another alternate embodiment that supplier 30 could remit payment to E-tailer 50 via any suitable electronic remittance of payment as known within the art of E-commerce and/or E-business. Prior to remitting payment to E-tailer 50, supplier 30 deducts processing/transaction fee 92 from cash value 60 and/or funds 62, wherein processing/transaction fee 92 is deposited into supplier's business account 75.

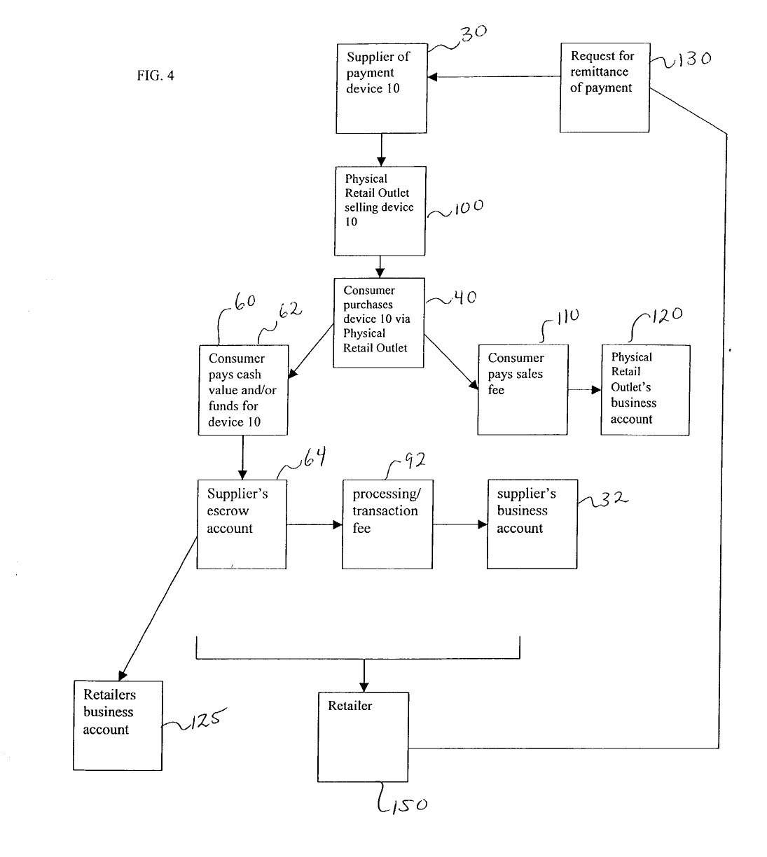

Referring now to FIG. 4, the present invention in an alternate embodiment is a payment device 10 utilized to conduct in-person purchases from a conventional retail outlet store (i.e., outside the realm of E-tailers and/or a global networking system) in a consignment form of retail. Specifically, supplier 30 of payment device 10 provides payment devices 10 to physical retail outlet 100 free-of-charge, wherein physical retail outlet 100 in turn, directly sells payment device 10 to consumer 40. If consumer 40 desires a pre-set or fixed value/denomination payment device 10, then consumer 40 pays physical retail outlet 100 an amount equivalent to the cash value 60 of the fixed value cash card/payment device 10 in addition to sales fee 110. If consumer desires a variable value payment device 10, then consumer 40 provides physical retail outlet 100 with a desired amount of funds 62 to be placed upon cash card/payment device 10 in addition to sales fee 110. Consumer 40 may directly purchase payment device 10 from physical retail outlet 100 via personal credit card, money order, cashier's check, cash and/or any other means as known within the art. Thereafter, cash value 60 and/or funds 62 are transferred to supplier 30 and held in supplier's 30 escrow account 64 for future payment to retailer 150 (as more fully described below), wherein sales fee 110 is deposited into physical retail outlet's 100 business account 120 as an earned commission.

Upon supplier's 30 confirmation of receipt/payment of cash value 60 and/or funds 62, payment device 10 is activated by supplier 30, permitting consumer 40 to make in-person purchases of goods and/or services from retailer 150. Consumer 40 purchases goods and/or services from retailer 150 via supplying retailer 150 with payment device 10, wherein retailer 150 charges the goods/services onto payment device 10—similar to methods of in-person purchasing of goods/services with a conventional credit card. To assist in charging the goods/services onto payment device 10, it is contemplated that payment device 10 could possess a scanning strip as known within the art of charge cards, in addition to card number 22. After transferring the purchased goods/services to consumer 40, retailer 150 seeks remittance of payment for the goods/services from supplier 30 via request 130, wherein request 130 is any suitable request for remittance of payment as known within the art of charge cards.

Supplier 30 in turn, remits payment to retailer 150 via accessing escrow account 64, and electronically wiring/transferring cash value 60 and/or funds 62 into business account 125 of retailer 150. Prior to remitting payment to retailer 150, supplier 30 deducts processing/transaction fee 92 from cash value 60 and/or funds 62, wherein processing/transaction fee 92 is deposited into supplier's business account 32. Aside from making an in-person purchase of payment device 10, consumer's 40 identity remains substantially private, as only card number 22 of payment device 10 are revealed, eliminating potential undesired disclosure of credit history, home address, birth name and/or any other related personal information during the purchase of goods/service with payment device 10. Additionally, should consumer's 40 card number 22 and/or card 20 in general be stolen from his/her person, the maximum value of theft would be equivalent to the value of payment device 10, thus drastically limiting overall monetary/financial loss by consumer 40.

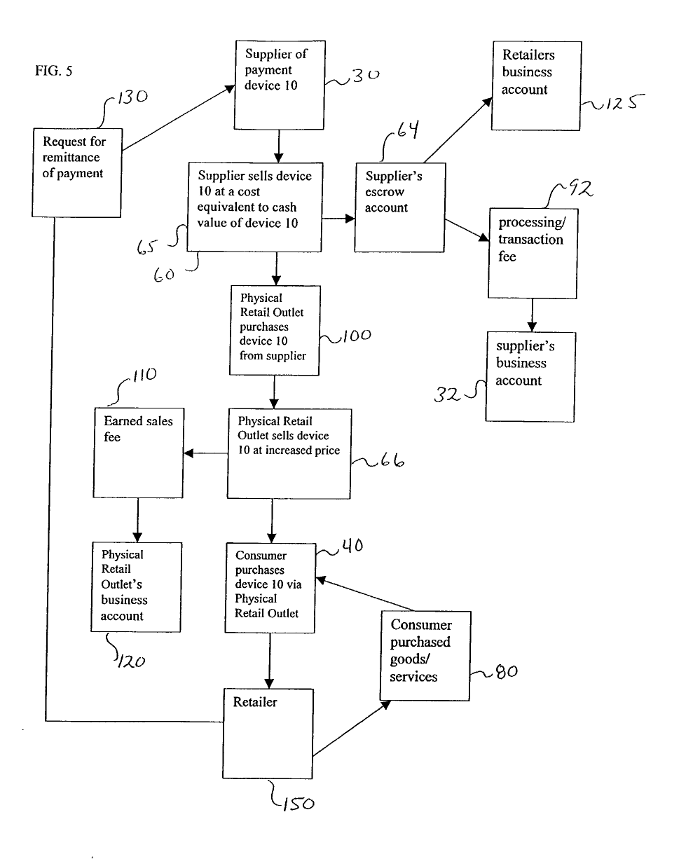

Referring now to FIG. 5, the present invention in an alternate embodiment is a payment device 10 utilized to conduct in-person purchases from a conventional retail outlet store (i.e., outside the realm of E-tailers and/or a global networking system) in a non-consignment form of retail. Specifically, supplier 30 of payment device 10 sells pre-set or fixed-value payment devices 10 to physical retail outlet 100 at cost 65, wherein cost 65 is an amount equivalent to the cash value 60 of the fixed value cash card/payment device 10. Physical retail outlet 100 in turn, directly sells fixed value payment device 10 to consumer 40 at an increased price 66, thus recouping original cost 65, and retaining sales fee 110. Consumer 40 may purchase fixed value payment device 10 from physical retail outlet 100 via personal credit card, money order, cashier's check, cash and/or any other means as known within the art. Cost 65 is held in supplier's 30 escrow account 64 for future payment to retailer 150 (as more fully described below), wherein sales fee 0.110 is deposited into physical retail outlet's 100 business account 120 as an earned profit.

Upon sale of fixed-value payment device 10 to consumer 40 by physical retail outlet 100, physical retail outlet 100 contacts supplier 30 for activation of fixed-value payment device 10, thus permitting consumer 40 to make in-person purchases of goods and/or services from retailer 150. Consumer 40 purchases goods and/or services from retailer 150 via supplying retailer 150 with payment device 10, wherein retailer 150 charges the goods/services onto payment device 10—similar to methods of in-person purchasing of goods/services with a conventional credit card. To assist in charging the goods/services onto payment device 10, it is contemplated that payment device 10 could possess a scanning strip as known within the art of charge cards, in addition to card number 22. After transferring the purchased goods/services 80 to consumer 40, retailer 150 seeks remittance of payment for goods/services 80 from supplier 30 via request 130, wherein request 130 is any suitable request for remittance of payment as known within the art of charge cards.

Supplier 30 in turn, remits payment to retailer 150 via accessing escrow account 64, and electronically wiring/transferring cash value 60 into business account 125 of retailer 150. Prior to remitting payment to retailer 150, supplier 30 deducts processing/transaction fee 92 from cash value 60, wherein processing/transaction fee 92 is deposited into supplier's business account 32.

It is contemplated in another alternate embodiment that a specific retail store 150 that is also an E-tailer 50 could sell payment devices 10 on location in the specific retail stores 150, wherein payment device 10 could be modified to ensure use thereof only with that specific E-tailer 50.

It is contemplated in an alternate embodiment that payment device 10 could be offered as on-line coupons, rebates and/or function as a medium onto which store credit is applied.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A payment system for providing an anonymously-purchased payment device, wherein said payment device is utilized according to a system, comprising:
a payment device selected from the group consisting of fixed-value payment devices and variable-value payment devices;
a supplier for supplying said payment device;
a retailer for receiving said payment device from said supplier;
a consumer for buying said payment device from said retailer, wherein said consumer pays said retailer for said payment device; and
a second retailer, wherein said second retailer sells goods and services to said consumer upon payment for said goods and services by said consumer via said payment device.

2. The payment system of claim 1, wherein said consumer also pays said retailer an activation fee for activating said payment device.

3. The payment system of claim 1, wherein said second retailer conducts business via a global networking system.

4. The payment system of claim 1, wherein at least one transaction fee is paid by said second retailer to said supplier for remittance of payment by said supplier to said second retailer for the value of said goods and services purchased by said consumer.

5. The payment system of claim 1, wherein said retailer is physically accessible by said consumer so that said consumer can make an in-person purchase of said payment device from said retailer.

6. The system of payment of claim 5, wherein said payment device is a card having at least one card number

7. The system of payment of claim 1, wherein said consumer is not required to disclose personal information to said retailer when purchasing said payment device from said retailer, and wherein said consumer is not required to disclose personal information to said second retailer when purchasing goods and services from said second retailer via said payment device.

8. The system of payment of claim 7, wherein purchases made by said consumer from said second retailer via said payment device are not traceable to said consumer.

9. A pre-paid anonymously-purchased payment device, comprising:
a card, wherein a user utilizes said card to make anonymous purchases.

10. The pre-paid anonymously-purchased payment device of claim 9, wherein at least one card number is disposed on said card, wherein said at least one card number is alterable by a user of said pre-paid payment device for purposes of anonymity and private purchasing power by said user.

11. The pre-paid anonymously-purchased payment device of claim 9, wherein said pre-paid anonymously-purchased payment device is selected from the group consisting of fixed-value pre-paid payment devices and variable-value pre-paid payment devices.

12. The pre-paid anonymously-purchased payment device of claim 11, wherein a consumer purchases said card from a supplier of said pre-paid anonymously-purchased payment device via paying the supplier an amount equivalent to said fixed-value pre-paid payment device in addition to a surcharge-activation fee.

13. The pre-paid anonymously-purchased payment device of claim 11, wherein a consumer purchases said card from a supplier of said pre-paid anonymously-purchased payment device via paying said supplier an amount equivalent to said variable-value pre-paid payment device in addition to a surcharge-activation fee.

14. The pre-paid anonymously-purchased payment device of claim 9, wherein said pre-paid anonymously-purchased payment device is utilized by said user to make private and anonymous purchases of goods and services from a retailer conducting business via a global networking system.

15. The pre-paid anonymously-purchased payment device of claim 14, wherein the purchase of said goods and services from said retailer by said user requires that said user only submit to said retailer said at least one card number of said pre-paid anonymously-purchased payment device and no additional personal information of said user.

16. The pre-paid anonymously-purchased payment device of claim 9, wherein the value of said pre-paid anonymously-purchased payment device can be renewed upon exhaustion.

17. A method of making anonymous purchases, comprising the steps of:
a) purchasing a pre-paid anonymously-purchased payment device from a purchasing source, wherein said prepaid anonymously-purchased payment device is supplied to said purchasing source by a supplier, and wherein said pre-paid anonymously-purchased payment device comprises:
a card, wherein said card is selected from the group consisting of fixed-value pre-paid payment devices and variable-value pre-paid payment devices; and
b) applying a payment amount to said pre-paid anonymously-purchased payment device to give said pre-paid anonymously-purchased payment device a monetary value;
c) purchasing goods and service from a retailer by submitting to said retailer at least one identifier disposed on said card and no other additional personal information.

18. The method of claim 17, further comprising the step of: purchasing said card from said purchasing source by paying said purchasing source an amount equivalent to said variable-value pre-paid payment device in addition to a surcharge-activation fee.

19. The method of claim 17, further comprising the step of: permitting the purchase of said pre-paid payment device from said purchasing source without having to submit any personal information to said purchasing source.

20. The method of claim 17, wherein said supplier charges said retailer a transaction-processing fee for remittance of payment to said retailer for the cost of said goods and services purchased via said pre-paid anonymously-purchased payment device.

21. The method of claim 17, wherein said retailer conducts business via a global networking system.
